(19) United States
(12) Patent Application Publication
(10) Pub. No.: US 2025/0207738 A1
(43) Pub. Date: Jun. 26, 2025

(54) APPARATUS FOR MONITORING PRESSURE WAVE OF PIPELINE

(71) Applicant: HS CMT Co.,LTD, Yongin-si (KR)

(72) Inventors: Byounghoon KIM, Hanam-si (KR); Shangyoon HWANG, Gwangju-si (KR); Sangjin YU, Seongnam-si (KR); Chanhong KIM, Gwangju-si (KR)

(21) Appl. No.: 18/999,921

(22) Filed: Dec. 23, 2024

(30) Foreign Application Priority Data
Dec. 22, 2023 (KR) 10-2023-0189455

(51) Int. Cl. F17D 5/06

(52) U.S. Cl. CPC F17D 5/06

(57) ABSTRACT

The present disclosure relates to an apparatus for monitoring pressure waves within a pipeline. It includes a pressure sensor to which a pressure of the fluid within the pipeline is directly transmitted without a separate impulse pipeline, which has a short response time of about 1˜10 ms to detect instantaneous excessive pressure waves, a time synchronization module for synchronization with a measurement time of a pressure sensor installed at a different position in the pipeline, a data logger configured to store measured values of the pressure sensor, a communication unit configured to transmit data of the data logger to the outside, and a controller configured to determine that excessive pressure waves occur in the pipeline so that only a pressure value measured by the pressure sensor within a predetermined time before and after a determination time point is stored in the data logger.

### CROSS-REFERENCE TO RELATED APPLICATION

This application claims priority to Korean Patent Application No. 10-2023-0189455 filed on Dec. 22, 2023 and all the benefits accruing therefrom under 35 U.S.C. § 119, the contents of which are incorporated by reference in their entirety.

### BACKGROUND

The present invention relates to a technology for routinely monitoring a pressure within a pipeline by being installed in a conduit through which a fluid passes, such as a water supply pipeline network, and more particularly, to an apparatus for measuring an excessive pressure wave that occurs momentarily due to an event inside a pipeline within the pipeline, and a pipeline network pressure monitoring system including a group of the apparatuses.

The supply of water in water networks is performed mainly by using a pressure difference. In areas located lower than the water supply source, water is supplied by natural differential head, and water is supplied by pressurizing the water using a pump. It is desirable to maintain a water pressure inside the pipeline at about 2 bars to about 4 bars based on the final acceptance criteria.

When an event occurs, such as an operation of a pump or valve installed to control an operation of a water supply network, a pipeline breakage, or a sudden large amount of water usage at receptors, a water hammer (water surge) occurs, and elastic waves, which are excessive pressure waves, are propagated very quickly to the upstream and downstream sides of a conduit. (a) to (d) of FIG. 1 illustrate excessive pressure waves according to various events. When the pump is started or stopped slowly using an inverter, water shocks do not occur significantly, but when the pump is turned on/off abruptly, the water shocks occur, and thus, excessive pressure waves such as that in (a) of FIG. 1 appear. This phenomenon also occurs with abrupt closure of the valve. The water shocks may also occur when water from the water supply network is pumped rapidly to be filled into a water tank in an apartment complex. Various water shocks increase in pipeline fatigue to lead to damage.

Currently, pressure gauges are installed in domestic pipelines to routinely monitor changes in pressure within the pipeline. However, the existing pressure gauges are very inadequate for detecting excessive pressure waves caused by the water shocks. The existing pressure gauges have a time constant that is longer than about 1 second or more, i.e., at the level of several seconds, to deteriorate a response speed and sensitivity. In addition, since such a pressure gauge is damaged when a surge pressure is introduced as the pressure gauge, a separate impulse pipeline in the shape of a pig's tail was installed, and a space having an expanded volume was provided inside the pressure gauge to attenuate the pressure. For this reason, as illustrated in FIG. 2, an instantaneous peak value (actual value, solid line) of excessive pressure waves caused by the water shocks is not detected, and only an insensitively relaxed pressure value (dotted line) is detected. When the existing pressure gauges are used, trends such as pressure increases and decreases over time are recognized, but there is a limitation of not being able to accurately detect the excessive pressure waves caused by the water shocks. Rather, it has been recommended to be used in a dull and relaxed manner for stability of an operation of the pressure gauge.

For smart maintenance of pipelines, it is necessary to accurately understand occurrence information of the events within the pipeline and the water hammer and excessive pressure waves caused by the events.

In addition, it is very difficult to detect urgent events such as pipeline breaks and leaks in real time using the existing pressure gauges.

### SUMMARY

The present disclosure provides an apparatus and system for monitoring pressure waves within a pipeline, which is capable of sensitively detecting excessive pressure waves, which are generated by water shocks due to an event in the pipeline, in real time and capable of operating with low power.

Other unspecified objects of the present disclosure will be additionally considered within the scope that can be easily inferred from the following detailed description and its effects.

According to an embodiment of the present disclosure, an apparatus for monitoring pressure waves within a pipeline includes: a pressure sensor which is installed by punching the pipeline, through which a fluid passes, to which a pressure of the fluid within the pipeline is directly transmitted without a separate impulse pipeline, which has a short response time of about 1 ms to about 10 ms to detect instantaneous excessive pressure waves; a time synchronization module for synchronization with a measurement time of a pressure sensor installed at a different position in the pipeline; a data logger configured to store measured values of the pressure sensor; a communication unit configured to transmit data of the data logger to the outside; and a controller configured to determine that excessive pressure waves occur in the pipeline so that only a pressure value measured by the pressure sensor within a predetermined time before and after a determination time point is stored in the data logger.

The time synchronization module may include a GPS module that receives a signal from a satellite and be configured to perform time synchronization in the range of several ms or less.

The data logger may include: a first memory in which normal pressure data periodically measured by the pressure sensor at regular intervals is stored; and a second memory in which event pressure data measured within a certain time period before and after a time point at which the controller determines that the excessive pressure waves have occurred is stored.

The controller may be configured to determine that the excessive pressure waves have occurred when a pressure value measured by the pressure sensor increases by a certain amount or more compared to a previously measured pressure value or an average value of pressures previously measured several times.

The apparatus may further include a magnetic switch, wherein the magnetic switch may include: a saddle branch pipeline installed to communicate with the pipeline so that a fluid is filled and protruding from the pipeline; a central shaft fixed inside the saddle branch pipeline along a protruding direction of the saddle branch pipe; a floating movable body fitted into the central shaft to be movable vertically along a pressure of the fluid within the pipeline and made of a conductive material; and a hall sensor installed to surround the saddle branch pipeline, thereby generating electricity due to movement of the floating movable body, wherein the pressure sensor may be configured to measure pressures for a certain period of time using the electricity generated by the magnetic switch as a switching signal. The central shaft disposed along the protruding direction of the saddle branch pipeline may be provided in the saddle branch pipeline, the floating movable body may be fitted into the central shaft, and a stopper configured to prevent the floating movable body from being separated to a lower side of the saddle branch pipeline may be provided at a lower side of the central shaft.

The apparatus may further include a piezoelectric element installed close to a through-hole defined by punching the pipeline so that the pressure within the pipeline is directly transmitted, wherein the piezoelectric element is configured to generate electricity due to changes in fluid pressure within the pipeline, wherein the pressure sensor may be configured to measure pressures for a certain period of time using the electricity generated by the piezoelectric element as a switching signal.

### BRIEF DESCRIPTION OF THE DRAWINGS

Exemplary embodiments can be understood in more detail from the following description taken in conjunction with the accompanying drawings, in which:

FIG. 1 is a view illustrating excessive pressure waves occurring due to an event within a pipeline;

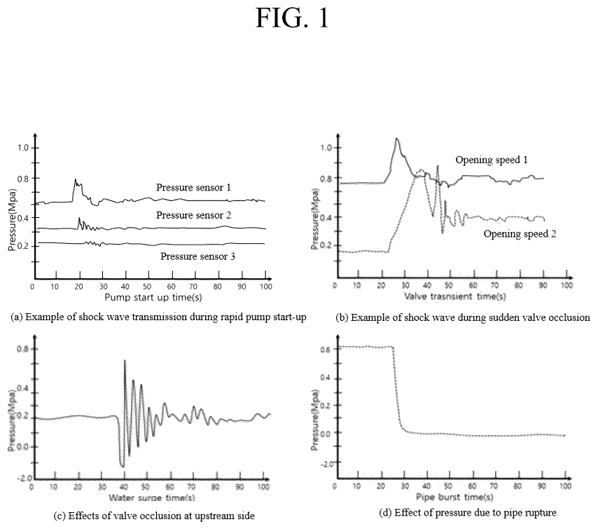

FIG. 2 is a graph comparing actual excessive pressure waves with pressure values measured by an existing pressure gauge;

FIG. 3 is a schematic view illustrating an apparatus for monitoring pressure waves within a pipeline according to an embodiment;

FIG. 4 is a schematic view illustrating a magnetic switch used in the apparatus for monitoring the pressure waves within the pipeline according to an embodiment;

FIG. 5 is a schematic view illustrating a piezoelectric element switch used in the apparatus for monitoring the pressure waves within the pipeline according to an embodiment; and

FIG. 6 is a view for explaining logic for determining an occurrence of an event within a pipeline in a controller according to an embodiment.

※ The attached drawings are presented for purposes of explanation only, and the technical scope of the present invention is not limited thereto.

### DETAILED DESCRIPTION OF EMBODIMENTS

Moreover, detailed descriptions related to well-functions or configurations will be ruled out in order not to unnecessarily obscure subject matters of the present invention.

Hereinafter, an apparatus for monitoring pressure waves within a pipeline according to an embodiment will be described in more detail with reference to the accompanying drawings.

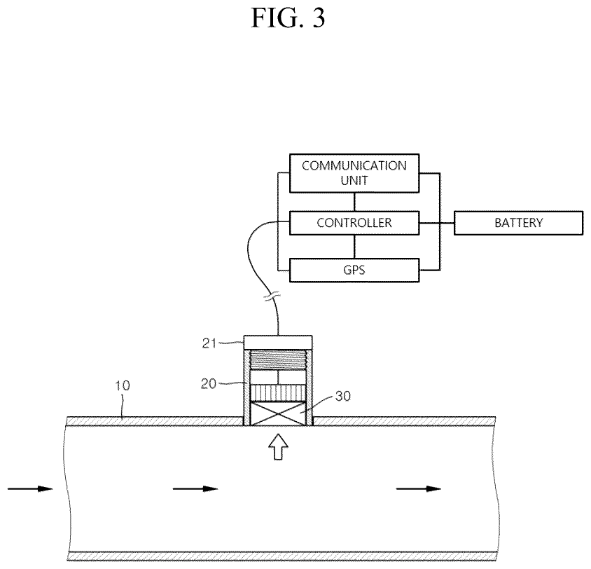

FIG. 3 is a schematic view illustrating an apparatus for monitoring pressure waves within a pipeline according to an embodiment.

Referring to FIG. 3, an apparatus for monitoring pressure waves of a pipeline according to an embodiment may include a pressure sensor 30, a time synchronization module, a data logger, a communication unit, a controller, and a power supply.

The pressure sensor 30 may be installed in a pipeline 10. More specifically, after punching the pipeline 10 through which a fluid flows, a hollow saddle 21 may be attached to a punched hole so that the saddle and the pipeline are mutually connected to each other. In addition, the pressure sensor 30 may be installed on the saddle 20. The important point is that a sensing part to which a pressure is applied to the pressure sensor 30 is disposed to almost correspond to an inner circumferential surface of the pipeline 10. As described above, in the pressure gauges installed in the existing water pipelines, the pipeline and the pressure gauge was connected through an impulse pipeline that is bent in the shape of a pig's tail so that water within the pipeline is introduced into the pressure gauge through the impulse pipeline. In addition, the water passing through the impulse pipeline was delivered to the sensing part of the pressure gauge only after passing through a suddenly expanded space inside the pressure gauge. As the impulse pipeline passes through the impulse pipeline and the wide space inside the pressure gauge, the pressure may be necessarily relieved. In the related art, this configuration was adopted to prevent the pressure gauge from being damaged when a surge pressure is directly transmitted to the pressure gauge. In other words, since the purpose of the pressure gauge in the related art was only to check the general trends of the pressure inside the pipeline, shock waves caused by events inside the pipeline were something to be avoided. However, since the purpose of the present disclosure is to secure data on excessive pressure waves resulting from events within the pipeline, this purpose may not be achieved with the existing configuration. Thus, in the present disclosure, the impulse pipeline may be removed, and thus, the configuration that relieves the pressure may be excluded within the pressure sensor, and the sensing part of the pressure sensor 30 may be disposed at the same position as the inner circumferential surface of the pipeline 10 so that the pressure within the pipeline is directly transmitted to the sensing part.

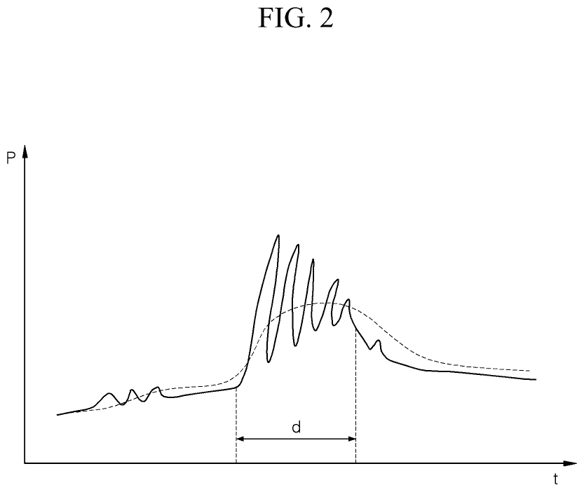

In addition, the pressure sensor used in the present disclosure has a very short response time (or time constant) of about 1 ms to about 10 ms. The pressure gauge used in the existing pipelines had a time constant of several seconds or more. If the response time is slow, an input value of the pressure sensor, which is changed rapidly over time, may not be displayed as an output value. In FIG. 2, a solid line may exhibit an actual waveform of excessive pressure waves generated in the pipeline 10, and a dotted line may exhibit a value output by the pressure gauge having a slow time constant of several seconds. The excessive pressure waves exhibit multiple peaks over a period of time (d, about 2 seconds to about 4 seconds) at a very rapid frequency. However, the pressure gauge having a slow time constant may not output rapidly changing input values as they are, but shows output values as a smoothed waveform similar to an average value. In other words, if the pressure gauge having the slow time constant is used, trends such as pressure rising and falling may be confirmed, but there is a limitation in obtaining accurate data on the excessive pressure waves. Since the pressure sensor used in the present disclosure has a very fast response time in a range of about 1 ms to about 10 ms, it may output an instantaneous peak value of the excessive pressure waves.

The present disclosure provides a data logger (not shown) that stores data measured by the pressure sensor. The data logger may be divided into a first memory and a second memory. As will be described later, normal pressure data may be stored in the first memory, and event pressure data may be stored in the second memory. The normal pressure data and the event pressure data will be described again later.

The apparatus according to the present disclosure may be provided with a time synchronization module.

The time synchronization module may be configured to synchronize a time between the plurality of pressure sensors. That is, a system in which a plurality of apparatuses for monitoring the pressure waves according to the present disclosure are installed in a pipeline network to comprehensively monitor the pipeline network may be considered. In the monitoring system, when an event such as a rupture at any point in the pipeline occurs, the resulting excessive pressure waves may be propagated through the upstream and downstream sides of the pipeline. Thus, the excessive pressure waves may be detected in order of the pressure sensor disposed at a close distance from the event occurrence point. When the excessive pressure waves are detected by the plurality of pressure sensors, the even occurrence point may be estimated using pipeline network GIS information, a time at which the event is detected by each pressure sensor, and a propagation speed of the excessive pressure waves. The important thing here is that the times of the pressure sensors installed in the pipeline have to be synchronized with each other. The times at which the excessive pressure waves are detected by each sensor may be different due to a difference in positions of the pressure sensors, and the time difference may be used to inversely calculate the event occurrence point. However, if the time synchronization is not achieved, this calculation may not be possible.

There are various methods that are capable of being used for the time synchronization, such as using a wireless communication network or using radio broadcast signals, but it is most desirable to use a GPS module that receives signals from satellites, as in this embodiment. The GPS signals transmitted from the satellites may be time-synchronized in very short units of 1 μs, or 1/1,000,000 seconds. In case in which the propagation is very fast, such as the excessive pressure waves, the synchronization in short time units may improve accuracy of the position estimation.

The excessive pressure waves may be propagated through water within the pipeline, and a speed of propagation may vary slightly depending on a material of the pipeline. For example, the propagation speed may be about 1,000 m/s in concrete and steel pipes, about 600 m/s in GRP pipes, about 400 m/s in flexible steel pipes, and about 200 m/s in PVC and PE pipes. Since the speed in the concrete cast iron pipes or steel pipes is about 1,000 m/s or more, a difference of about 10 ms (about 0.01 sec) in time synchronization may cause a difference of about 10 m in position, which causes an error in estimating the event occurrence point. Furthermore, a difference of about 0.1 seconds in time synchronization may result in an error of about 100 m in position. In this embodiment, since the GPS module is used to synchronize the times of the pressure sensors in about 1 ms units, the estimation error of the event occurrence position due to a measurement time error of the pressure sensor may be significantly reduced.

The apparatus for monitoring the pressure waves according to the present disclosure may be provided with the communication unit. Data stored in the data logger may be transmitted to a central management server via the communication unit. The communication unit may use various means such as an LTE, and as this is a well-known technology, detailed descriptions will be omitted.

As described above, the pressure sensor used in the present disclosure may output pressure values more than 100 times per second, and if all of this data is to be stored, capacity of the data logger has to be very large. Thus, the present disclosure may provide a method capable of storing all the pressure values detected as the excessive pressure waves caused by the events while reducing an amount of data.

The controller may divide the data output from the pressure sensor into normal pressure data and event pressure data, store the normal pressure data in the first memory of the data logger, and stores the event pressure data in the second memory. The details how to store the output values of the pressure sensor as data in the controller will be described. The pressure sensor may continuously measure the pressure and output the pressure data, and all data may be temporarily stored in the data logger. In addition, if the pressure inside the pipeline is not changed drastically during the corresponding time, such as the occurrence of the event, specific data (e.g., the last data in a certain period) of the data measured during the corresponding time may be stored in the first memory as a representative value of the normal pressure data, and all remaining stored data may be deleted. Since only one or few data as the representative value for a certain period of time is stored, and all the remaining data is deleted, the storage space in the data logger may be secured. If there was no sudden change in pressure during the period, there is no problem in determining the pressure status of the pipeline by using the above method. However, if there is a sudden change in pressure due to the event, etc., all the excessive pressure waves caused by the event may be treated as event pressure data and stored in the secondary memory.

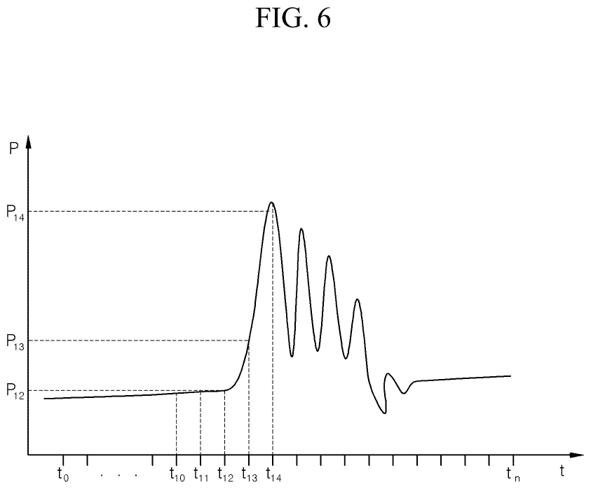

To implement the above-described method, the controller has to read the occurrence of the event. The controller may compare the data output from the pressure sensor at the current point in time with the data at the previous point in time to calculates a difference therebetween. Referring to FIG. 6, there is almost no change in pressure value from a time point t0 to a time point t12. However, at a time point t13, the pressure value suddenly increased sharply to an input value P13 compared to a previous pressure value P12. In the controller, if an amount of change suddenly increases compared to the existing amount, this may be interpreted as the event. Particularly, if the pressure change is large only once, there may be possibility of noise, but if the pressure change occurs more than twice, for example about 2 times to about 4 times to be continued, it may be clearly interpreted as the event occurrence. When the event is determined to have occurred, all data output from an initial time point to previous about 1 second and afterward about 4 seconds may be treated as the event pressure data and stored in the secondary memory. About 1 second and about 4 seconds may be only examples for explanation and may be changed. After the excessive pressure wave due to the event has passed, a process of storing and deleting the normal pressure data and sampling and storing only the representative value may be repeated. Through the above process, all the excessive pressure wave data before and after the event occurs may be stored in the secondary memory for analysis, and only the representative value of the normal pressure data without any special changes may be stored to save the storage space of the data logger.

Since both the communication unit and the pressure sensor used in this embodiment are driven by power, it is necessary to reduce power consumption so as to maintain the device for a long time. It is noted that, in this embodiment, a battery pack that is an independent power source based on a low-power operation may also be used as a power source.

In the present disclosure, to reduce the power consumption, a switch may be further provided so that the pressure sensor operates only when the event occurs within the pipeline.

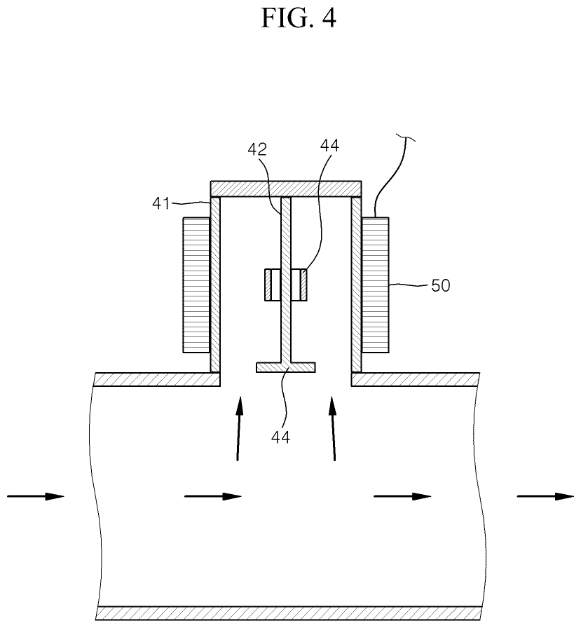

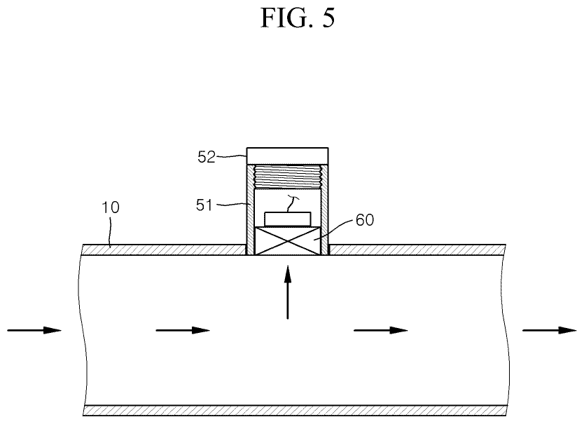

The switch may use two forms as illustrated in FIGS. 4 and 5.

FIG. 4 is a schematic view illustrating a magnetic switch used in the apparatus for monitoring the pressure waves within the pipeline according to an embodiment, and FIG. 5 is a schematic view illustrating a piezoelectric element switch used in the apparatus for monitoring the pressure waves within the pipeline according to an embodiment.

Referring to FIG. 4, a first switch may be a magnetic switch.

The magnetic switch is provided with a saddle branch pipeline 41, a floating moving body 44, and a hall sensor 50. The saddle branch pipeline 41 may be a hollow pipeline and be coupled to surround a pounced hole after punching the pipeline. Thus, the saddle branch pipeline 41 may be disposed to protrude along a diameter direction of the pipeline and communicate with the inside of the pipeline so that a fluid is filled into the saddle branch pipeline 41. An upper side of the saddle branch pipeline 41 may be covered with a cover. A central shaft 42 may be provided along the protruding direction of the saddle branch pipe inside the saddle branch pipeline 41. The floating movable body 44 may be made of a conductive material, have a hollow shape, and be fitted into the central shaft 42. The floating movable body 44 may move upward and downward along the central shaft 42, but a downward displacement may be limited by a stopper 43 provided at a lower portion of the central shaft 42. In addition, a spring and an additional device may be installed at upper and lower sides of the central shaft so as to be disposed at a central portion of the central shaft in a pressure equilibrium state of the floating movable body 33.

In addition, a hall sensor 50 may be coupled to surround the saddle branch pipeline 41. The hall sensor 50 may generate an electric signal through electromagnetic induction. That is, when the floating movable body 44 made of a conductive material suddenly moves upward and downward along the central shaft, electricity may be generated in an electromagnet or the hall sensor around with a coil is wound. When water hammer occurs due to rapid opening and closing of the valve in the pipeline or rapid turning on/off of the pump, the excessive pressure waves may be generated. When the excessive pressure waves are propagated along the pipeline toward the saddle branch pipeline 41, the floating movable body 44 may also experience rapid displacement due to the pressure to generate electricity in the hall sensor. The hall sensor 50 may be connected to the pressure sensor 30, and an electric signal generated from the hall sensor may become a switching signal that operates the pressure sensor 30. The pressure sensor 30 may be turned on by the hall sensor according to set setting, a pressure may be measured and output for a set period of time (e.g., several seconds), be stored in the data logger, and then turn off again or be switched into a sleep mode.

In the present disclosure, the event in the pipeline may be detected using the above-described magnetic switch, and when a displacement sensor operates by the event detection, the pressure data on the excessive pressure waves may be measured and stored.

The switch illustrated in FIG. 5 may use the piezoelectric element 60. Like the magnetic switch, the pipeline may be punched, and the saddle branch pipeline 51 may be coupled. In addition, the switch may be installed at the lowest point of the saddle branch pipeline 51, that is, at a point close to an inner surface of the pipeline, that is, may be fitted into a through-hole defined by punching the pipeline or be installed at an upper side of the through-hole. The piezoelectric element may be a device that generates electricity through changes in pressure and may be used as the switch. That is, when the excessive pressure waves occur due to the event within the pipeline, the excessive pressure waves may be transmitted along the pipeline to apply a pressure to the piezoelectric element 60. The piezoelectric element 60 may generate electricity in response to a rapid change in pressure, and the electric signal may have a switching function that re-operates the pressure sensor that was turned off or in dormant mode. When the pressure sensor is turned on once, the pressure sensor may measure and output the excessive pressure waves for a set period of time, such as several seconds, to stores the measured and output value in the data logger.

In the present disclosure, the above-described magnetic switch or piezoelectric element switch may be used to monitor only the excessive pressure waves when the event occurs without separately measuring the normal pressure data in the pipeline. Alternatively, the pressure sensor may be turned on at regular intervals (e.g., about 5 minutes) to measure the normal pressure data, remain in sleep mode or is turned off for the rest of the time, and then, when the event is detected by the magnetic switch or the piezoelectric element switch, the pressure sensor may be turned on to measure the excessive pressure waves. Since the pressure sensor operates only at a periodic point at which the normal pressure data is measured and at a time point at which the event occurs, it is possible to monitor both the normal and abnormal pressures in the pipeline while minimizing the power consumption.

As described above, in the present disclosure, the controller, the magnetic switch, or the piezoelectric element switch may be used to detect the event within the pipeline, and the excessive pressure waves may be measured by the pressure sensor to very precisely monitor the pressure change trends due to the event within the pipeline. In addition, the pressure sensor may monitor the normal pressure situation of the pipeline by operating periodically and sequentially under the control of the control program built into the pressure sensor itself or the controller.

As described above, if the pressure inside the pipeline is monitored and stored to be divided into the normal pressure and the event pressure, when the data is accumulated, an efficient solution for the operation of the pipeline may be derived based on the data. Furthermore, after installing the plurality of apparatuses in the pipeline like the present disclosure to build the monitoring system, the excessive pressure waves may be generated through artificial manipulation such as the opening and closing of the valve or the turn on/off of the pump, etc., and then, related data may be collected.

As described above, when using the apparatus for monitoring the pressure waves and the monitoring system according to the present disclosure, in which the plurality of apparatuses are installed in the pipeline and which is connected to a central server, the normal and abnormal pressures in the pipeline may be precisely monitored.

In addition, in the system for monitoring the pressure waves, when using the difference at the time point at which the excessive pressure waves are transmitted to the pressure sensors installed at the different locations, the transmission speed of the excessive pressure wave, and the flow speed of the fluid, the transmission speed of the excessive pressure waves, and the flow speed of the fluid, the positions at which the event occurs may be estimated.

When using the apparatus for monitoring the pressure waves and the monitoring system according to the present disclosure, in which the plurality of apparatuses are installed in the pipeline and which is connected to a central server, the normal and abnormal pressures in the pipeline may be precisely monitored.

Particularly, in the apparatus for monitoring the pressure waves within the pipeline according to the present disclosure, the sensitive pressure sensor having the very fast response time of several milliseconds may be used and disposed so that the pressure of the fluid within the pipeline is transmitted without any increase or decrease to secure the precise data on the excessive pressure waves resulting from the occurrence of the event within the pipeline.

In addition, in the system for monitoring the pressure waves, when using the difference at the time point at which the excessive pressure waves are transmitted to the pressure sensors installed at the different locations, the transmission speed of the excessive pressure wave, and the flow speed of the fluid, the transmission speed of the excessive pressure waves, and the flow speed of the fluid, the positions at which the event occurs may be estimated.

Although effects are not considered herein, the effects described in this specification and their provisional effects, which are expected by the technical features of the present disclosure, may be considered as the effects described in this specification.

The scope of protection of the present disclosure is not limited to the description and expression of the embodiments explicitly described above. Further, it will be understood that the protective scope of the present invention is not limited by obvious modifications or substitutions in the technical fields of the present invention.

What is claimed is:

1. An apparatus for monitoring pressure waves within a pipeline, the apparatus comprising:
a pressure sensor which is installed by punching the pipeline, through which a fluid passes, to which a pressure of the fluid within the pipeline is directly transmitted without a separate impulse pipeline, which has a short response time of about 1 ms to about 10 ms to detect instantaneous excessive pressure waves;
a time synchronization module for synchronization with a measurement time of a pressure sensor installed at a different position in the pipeline;
a data logger configured to store measured values of the pressure sensor;
a communication unit configured to transmit data of the data logger to the outside; and
a controller configured to determine that excessive pressure waves occur in the pipeline so that only a pressure value measured by the pressure sensor within a predetermined time before and after a determination time point is stored in the data logger.

2. The apparatus of claim 1, wherein the time synchronization module comprises a GPS module that receives a signal from a satellite and is configured to perform time synchronization in the range of several ms or less.

3. The apparatus of claim 1, wherein the data logger comprises:
a first memory in which normal pressure data periodically measured by the pressure sensor at regular intervals is stored; and
a second memory in which event pressure data measured within a certain time period before and after a time point at which the controller determines that the excessive pressure waves have occurred is stored.

4. The apparatus of claim 1, wherein the controller is configured to determine that the excessive pressure waves have occurred when a pressure value measured by the pressure sensor increases by a certain amount or more compared to a previously measured pressure value or an average value of pressures previously measured several times.

5. The apparatus of claim 1, further comprising a magnetic switch,
wherein the magnetic switch comprises:
a saddle branch pipeline installed to communicate with the pipeline so that a fluid is filled and protruding from the pipeline;
a central shaft fixed inside the saddle branch pipeline along a protruding direction of the saddle branch pipe;
a floating movable body fitted into the central shaft to be movable vertically along a pressure of the fluid within the pipeline and made of a conductive material; and
a hall sensor installed to surround the saddle branch pipeline, thereby generating electricity due to movement of the floating movable body,
wherein the pressure sensor is configured to measure pressures for a certain period of time using the electricity generated by the magnetic switch as a switching signal.

6. The apparatus of claim 5, wherein the central shaft disposed along the protruding direction of the saddle branch pipeline is provided in the saddle branch pipeline,
the floating movable body is fitted into the central shaft, and
a stopper configured to prevent the floating movable body from being separated to a lower side of the saddle branch pipeline is provided at a lower side of the central shaft.

7. The apparatus of claim 1, further comprising a piezoelectric element installed close to a through-hole defined by punching the pipeline so that the pressure within the pipeline is directly transmitted, wherein the piezoelectric element is configured to generate electricity due to changes in fluid pressure within the pipeline,
wherein the pressure sensor is configured to measure pressures for a certain period of time using the electricity generated by the piezoelectric element as a switching signal.
